(19) United States
(12) Patent Application Publication
(10) Pub. No.: US 2026/0149276 A1
(43) Pub. Date: May 28, 2026

(54) Edge-Computation-Based Dynamic Optimization Control System for Energy Storage Cluster

(71) Applicant: Guangdong Shunde Electric Power Design Institute Co., Ltd., Foshan (CN)

(72) Inventors: Jian LI, Foshan (CN); Ping YIN, Foshan (CN); Xiaonan DENG, Foshan (CN); Hui GUO, Foshan (CN); Yongquan HE, Foshan (CN); Haiwen CHEN, Foshan (CN); Zhichao CHEN, Foshan (CN); Liming FENG, Foshan (CN)

(21) Appl. No.: 19/211,361

(22) Filed: May 19, 2025

(30) Foreign Application Priority Data
Nov. 27, 2024 (CN) 2024117072566

(51) Int. Cl. H02J 3/00; G05B 13/02; H02J 3/32

(52) U.S. Cl. CPC H02J 3/004; G05B 13/027; H02J 3/32; H02J 2103/30

(57) ABSTRACT

The present application discloses an edge-computation-based dynamic optimization control system for an energy storage cluster, and relates to the technical field of energy storage clusters. The edge-computation-based dynamic optimization control system includes: acquiring historical data of the energy storage cluster and local data of edge nodes; predicting a time sequence by using an ARIMA model, recognizing and correcting a non-linear error by using a BP neural network, and outputting a final power prediction value. By means of short-term trend prediction of ARIMA and error correction of the BP neural network, the stable operation of an energy storage system in a grid can be guaranteed; by performing local BP neural network model training on each edge node, distributed computation resources can be sufficiently utilized; and under a synergistic effect of a bi-level optimization model, a final power distribution solution and a transmission path optimization result will be outputted.

### TECHNICAL FIELD

The present application relates to the technical field of energy storage clusters, in particular to an edge-computation-based dynamic optimization control system for an energy storage cluster.

### BACKGROUND ART

With the wide application of renewable energy and the continuous development of a distributed energy technology, an energy storage cluster has become a key component in an energy management system. An energy storage system can store excess electric energy when power supply is surplus, and can release electric energy at a peak of a power demand, thereby implementing the balance and adjustment of a power load. A traditional management and control method for the energy storage system is difficult to respond to dynamic load changes in real time due to the low efficiency of energy distribution. With the introduction of an edge computing technology, computing resources are sunk to an edge of a network, which improves the real-time property and reliability of data processing, so that the energy storage system can manage and schedule energy of the distributed nodes more efficiently.

However, a traditional power prediction method is relatively sensitive to a linear feature of a time sequence so as to be difficult to cope with nonlinear changes in the operation of the energy storage cluster, which results in inaccurate prediction results, and meanwhile, most of existing energy scheduling algorithms are based on fixed rules and models and are lack of a real-time feedback mechanism for dynamic path loss between energy storage nodes and load nodes, which results in a problem of lower power distribution and transmission efficiency.

### SUMMARY OF THE INVENTION

In view of the problem existing in the above-mentioned existing edge-computation-based dynamic optimization control system for an energy storage cluster, the present application is provided.

Therefore, a problem to be solved in the present application lies in that a traditional power prediction method is relatively sensitive to a linear feature of a time sequence so as to be difficult to cope with nonlinear changes in the operation of the energy storage cluster, which results in inaccurate prediction results; and meanwhile, most of existing energy scheduling algorithms are based on fixed rules and models and are lack of a real-time feedback mechanism for dynamic path loss between energy storage nodes and load nodes, which results in a problem of lower power distribution and transmission efficiency.

In order to solve the above-mentioned technical problem, the present application provides the following technical solutions: an edge-computation-based dynamic optimization control system for an energy storage cluster includes:
a data acquisition module acquiring historical data of the energy storage cluster and local data of edge nodes;
a power prediction module predicting a time sequence by using an ARIMA (Autoregressive Integrated Moving Average) model, recognizing and correcting a non-linear error by using a BP (Back Propagation) neural network, outputting a final power prediction value, deploying the model based on the edge nodes, and performing global updating;
a bi-level optimization model module constructing a bi-level optimization model to perform dynamic distribution and path optimization of the energy storage cluster, computing transmission paths and loss based on a lower-level optimization model, feeding the transmission loss back to affect power distribution of an upper-level optimization model, and iteratively computing a power distribution result;
a dynamic offloading strategy module defining a scheduling strategy based on the energy storage cluster, and defining a dynamic offloading strategy based on the edge nodes; and
an anomaly detection module constructing an anomaly detection model based on an LSTM (Long Short Term Memory) neural network to recognize abnormal operation of the energy storage cluster, and performing local or cloud storage and backup on edge node data.

As a preferred solution of the edge-computation-based dynamic optimization control system for an energy storage cluster in the present application, the acquiring historical data of the energy storage cluster and local data of edge nodes includes:
performing data acquisition and normalization based on the historical data, including real-time operation state data of a power output, a load, a voltage and a current of each node and further including environmental variable data of a temperature and a humidity, of the energy storage cluster; and
performing acquisition and storage according to the local data corresponding to the edge nodes of the energy storage cluster.

As a preferred solution of the edge-computation-based dynamic optimization control system for an energy storage cluster in the present application, the predicting a time sequence by using an ARIMA model, recognizing and correcting a non-linear error by using a BP neural network, and outputting a final power prediction value includes:
performing a prediction operation of the time sequence based on normalized historical power data of the energy storage cluster by using the ARIMA model, which is formulated as:

$${P}_{t} = {\sum }_{i = 1}^{p} {α}_{i} {P}_{t - i} + {\sum }_{j = 1}^{q} {β}_{i} {∈}_{t - j} ;$$

wherein Pₜ represents a power prediction value at a time point t, Pₜ₋ᵢ represents historical power data of time t-i, ϵₜ₋ⱼ represents an error at a time point t-j, αᵢ represents an autoregressive term coefficient, βᵢ represents a moving average term coefficient, and p and q respectively represent an autoregressive order and a moving average order;
performing parameter estimation on the ARIMA model by maximum likelihood estimation (MLE), and optimizing and determining αᵢ and βᵢ by the MLE by means of a historical data training model;
constructing a BP neural network model including an input layer, a hidden layer and an output layer, wherein the input layer inputs an output of the ARIMA model, the hidden layer recognizes and corrects the non-linear error outputted by the ARIMA model, and the output layer outputs the final power prediction value, which is formulated as:

$$E = \frac{1}{2} {\sum }_{t = 1}^{N} {( {P}_{t , act} - {P}_{t , pre} )}^{2} ;$$

wherein P_{t,act} represents a real power value, P_{t,pre} represents a predicted power value, N represents the total number of real data, and E represents an error term;
training the model by using a training set, selecting a cross entropy loss function to compute a difference of predicted and actual labels of the BP neural network model, performing gradient descent optimization by using an Adam optimizer, updating a weight of the BP neural network model, and stopping iteratively outputting model parameters for updating the model when the loss of the model is no longer reduced significantly in a process of continuous iteration; and
after power prediction is completed, using the sum of linear prediction of the ARIMA model and non-linear error correction of the BP neural network as the final power prediction value and a basis for next optimal scheduling.

As a preferred solution of the edge-computation-based dynamic optimization control system for an energy storage cluster in the present application, the deploying the model based on the edge nodes, and performing global updating includes:
respectively training a local BP neural network model for each edge node, wherein used training data is local historical power data;
after local training is completed, sending updated model parameters to a central server;
performing weighted average on model parameters of all the nodes by the central server to update a global model; and
sending the updated global model back to each edge node for next round of training.

As a preferred solution of the edge-computation-based dynamic optimization control system for an energy storage cluster in the present application, the constructing a bi-level optimization model to perform dynamic distribution and path optimization of the energy storage cluster includes:
based on computation for the final power prediction value, constructing the bi-level optimization model including the upper-level optimization model and the lower-level optimization model to perform dynamic distribution and path optimization of the energy storage cluster;
defining modules or devices receiving and consuming electric energy released by energy storage units as load nodes;
defining an objective of the upper-level optimization model as minimizing total energy consumption and operation costs, wherein an objective function is formulated as:

$$min {F}_{e n} = {\sum }_{i = 1}^{M} ( {C}_{s t , i} + {C}_{\vert o , i} ) ;$$

wherein Fₑₙ represents the total power consumption, M represents the total number of energy storage nodes, C_{st,i} represents a power consumption cost of an i^{th} energy storage node, and C_{lo,i} represents a power consumption cost of an i^{th} load node;
defining an objective of the lower-level optimization model as finding a transmission path with the minimum loss between the energy storage units and the load nodes by using a shortest path algorithm, wherein an objective function is formulated as:

$$mins = {\sum }_{i = 1}^{M} {\sum }_{j = 1}^{B} {l}_{i , j} ;$$

$${l}_{i , j} = {R}_{i , j} \cdot {l}_{i , j}^{2} ;$$

wherein M and B respectively represent the number of the energy storage nodes and the number of the load nodes, l_{i,j} represents power transmission loss between an energy storage node i and a load node j, s represents total transmission loss, R_{i,j} represents line resistance between the nodes i and j, and I_{i,j} represents a current between the nodes i and j; and
computing the shortest path from the energy storage nodes to the load nodes by adopting a Dijkstra algorithm.

As a preferred solution of the edge-computation-based dynamic optimization control system for an energy storage cluster in the present application, the computing transmission paths and loss based on a lower-level optimization model, feeding the transmission loss back to affect power distribution of an upper-level optimization model, and iteratively computing a power distribution result includes:
initializing the power distribution, and performing distribution by each energy storage node according to remaining power thereof and demands of the load nodes, which is formulated as:

$${P}_{i , j}^{in} = \frac{{E}_{i} ( t )}{{\sum }_{k = 1}^{B} {D}_{k} ( t )} \cdot {D}_{j} ( t ) ;$$

wherein

$${P}_{i , j}^{in}$$

represents power distributed to the load node j by an energy storage node,Eᵢ(t) represents total available energy of the energy storage units at time t, Dₖ(t) and Dⱼ(t) respectively represent energy demands of load nodes j and k at the time t, and B represents the number of the load nodes;
computing and substituting initially distributed power of each energy storage unit into the objective function of the upper-level optimization model, and computing total consumption of initial power distribution, which is formulated as:

$${F}_{i n} = {\sum }_{i = 1}^{M} {\sum }_{j = 1}^{B} ( {C}_{st , i} \cdot {P}_{i , j}^{i n} + {C}_{lo , j} \cdot {P}_{i , j}^{i n} ) ;$$

wherein Fᵢₙ represents a total cost of power distribution, and C_{st,i} and C_{lo,j} respectively represent a power consumption cost of the energy storage node i and a power demand cost of the load node j;
computing the transmission paths and loss between the energy storage nodes and the load nodes based on the lower-level optimization model by adopting the Dijkstra algorithm, and feeding the transmission loss back to affect the power distribution of the upper-level optimization model, which is formulated as:

$${F}_{t o t} = {\sum }_{i = 1}^{M} {\sum }_{j = 1}^{B} ( {C}_{st , i} \cdot {P}_{i , j}^{i n} + {C}_{lo , j} \cdot {P}_{i , j}^{i n} + {l}_{i , j} ) ;$$

wherein Fₜₒₜ represents a total power cost including a power distribution cost and a transmission cost;
adjusting a power distribution strategy by using a gradient descent method according to the feedback transmission loss, and minimizing the objective function Fₜₒₜ to compute a new power distribution solution; and
defining a convergence threshold based on the historical data, and when a variable of the objective function is lower than a preset convergence threshold in a plurality of iterations of power distribution, stopping iteration to obtain a final power distribution result.

As a preferred solution of the edge-computation-based dynamic optimization control system for an energy storage cluster in the present application, the defining a scheduling strategy based on the energy storage cluster includes:
balancing a load demand, renewable energy power generation, energy storage system discharge and grid power supply, and clarifying that the sum of renewable energy power, grid power and discharging power of the energy storage units is equal to the sum of a total load demand and charging power of an energy storage system; and
defining the scheduling strategy, checking a power output of renewable energy, if the output of the renewable energy exceeds the load demand, charging the energy storage units, if the output of the renewable energy is not enough to meet the load demand, complementing insufficient power by the energy storage units, and if the energy storage units are not enough to meet the load demand either, performing complementation by means of a grid.

As a preferred solution of the edge-computation-based dynamic optimization control system for an energy storage cluster in the present application, the defining a dynamic offloading strategy based on the edge nodes includes:
defining the dynamic offloading strategy based on the edge nodes completing training, monitoring operation data of each edge node in real time, computing a load rate, and meanwhile, monitoring a network bandwidth;
computing an offloading feasibility index for an edge node task, which is formulated as:

$${I}_{k} = \frac{{T}_{lo , k} - {T}_{ed , k}}{{T}_{lo , k}} \cdot \frac{{R}_{av}}{{R}_{k}} \cdot \frac{{U}_{n} ( t )}{{C}_{n}} ;$$

wherein Iₖ represents an offloading feasibility index of a k^{th} task, T_{lo,k} represents delay time of local processing of the task k, T_{ed,k} represents delay time of processing from the task k to an edge cloud, Rₐᵥ represents the current available network bandwidth, Rₖ represents a bandwidth required for offloading the task k, Cₙ, represents the maximum computing power of an edge node n, and Uₙ(t) represents the current performance utilization rate of the node n;
computing a feasibility index of an offloadable task based on the historical data, and using the sum of an average value and a standard deviation as a feasibility threshold, and if Iₖ is greater than or equal to the feasibility threshold, indicating that the task k is offloadable;
determining an offloading decision variable xx based on a judgment whether the task k is offloaded or not, if the task k is offloaded to the edge cloud, indicating 1, or otherwise, indicating 0;
defining an execution condition, if T_{lo,k} is greater than T_{ed,k}, indicating that the task is offloadable, if a total bandwidth demand of an offloaded task is less than Rₐᵥ, indicating that the task is offloadable, and if the load rate of the edge nodes exceeds the maximum load rate, indicating that the task is offloadable;
defining a dynamic decision based on a minimized total energy consumption and delay, which is formulated as:

$$min G = {\sum }_{k = 1}^{K} ( {x}_{k} \cdot ( {T}_{e d , k} + {E}_{e d , k} ) + ( 1 + {x}_{k} ) \cdot ( {T}_{lo , k} + {E}_{lo , k} ) ) ;$$

wherein minG represents a minimized optimization objective, K represents the total number of tasks, and E_{ed,k} and E_{lo,k} respectively represent energy consumption for offloading the task k to the edge cloud and energy consumption for local processing of the task k;
based on the minimized optimization objective, executing an offloading task in real time, and performing network transmission; and assigning the task to a cloud node for processing; and
continuously monitoring the offloaded task to ensure that the offloading task is completed within a preset time, and if network congestion or excessive delay occurs in an offloading process, trying, by the system, to reassign the task to be executed locally.

As a preferred solution of the edge-computation-based dynamic optimization control system for an energy storage cluster in the present application, the constructing an anomaly detection model based on an LSTM neural network to recognize abnormal operation of the energy storage cluster includes:
constructing the anomaly detection model including an input layer, an LSTM layer and an output layer based on the LSTM neural network, wherein the input layer inputs historical operation data of the energy storage cluster, the LSTM layer is used for capturing dynamic changes in the time sequence, and the output layer outputs an operation state of an energy storage cluster of the next time step;
computing a difference of a predicted result and an actual label of the anomaly detection model by using a training set and selecting a cross entropy loss function, performing gradient descent optimization by using an Adam optimizer, updating parameters of the anomaly detection model, and stopping iteratively outputting model parameters when the loss of the model is no longer reduced significantly in a process of continuous iteration; and
using the sum of an average value and a double standard deviation based on the historical data as an anomaly threshold, and if a predicted output of the anomaly detection model is greater than the anomaly threshold, regarding that the operation of the energy storage units is abnormal, and performing dynamic load balancing scheduling based on the number of other unfailed energy storage units.

As a preferred solution of the edge-computation-based dynamic optimization control system for an energy storage cluster in the present application, the performing local or cloud storage and backup on edge node data includes:
giving an anomaly alarm to maintenance personnel by means of an alarm based on a judgment whether the operation of the energy storage units is abnormal;
performing data encryption on recorded alarm time and the data by adopting RSA (Rivest-Shamir-Adleman), and transmitting the data to a cloud database by adopting a TLS (transport layer security) protocol; and
synchronously performing local backup and cloud storage on the data of the edge nodes and the central server.

The present application has the beneficial effects that: by means of short-term trend prediction of ARIMA and error correction of the BP neural network, a response to power fluctuation can be made more rapidly, and power distribution can be optimized, so that the stable operation of an energy storage system in a grid can be guaranteed; by performing local BP neural network model training on each edge node, distributed computation resources can be sufficiently utilized; under a synergistic effect of a bi-level optimization model, a final power distribution solution and a transmission path optimization result will be outputted to ensure, under the fluctuation of a load demand and power supply, that efficient operation can be implemented, energy consumption can be reduced, and the utilization of renewable energy can be maximized; and by means of the dynamic offloading strategy for each edge node, it is ensured that the normal operation of a task can be still maintained even if there is a problem during cloud processing, so that the robustness of the system is enhanced.

### BRIEF DESCRIPTION OF THE DRAWINGS

In order to describe the technical solutions in the embodiments of the present application more clearly, the accompanying drawings required for describing the embodiments will be briefly introduced below. Apparently, the accompanying drawings in the following description show only some embodiments of the present application, and those of ordinary skill in the art may still derive other accompanying drawings from these accompanying drawings without creative efforts.

FIG. 1 is a schematic structural diagram of an edge-computation-based dynamic optimization control system for an energy storage cluster.

FIG. 2 is a schematic process diagram of an edge-computation-based dynamic optimization control system for an energy storage cluster.

### DETAILED DESCRIPTION OF THE INVENTION

In order to make the above-mentioned objects, features, and advantages of the present application more obvious and comprehensible, the specific implementations of the present application will be described in detail below in conjunction with the accompanying drawings of the description.

A lot of specific details will be described in the following description to facilitate sufficiently understanding the present application. However, the present application can also be implemented in other ways different from ways described herein. Similar popularizations can be made by the skilled in the art without departing from the contents of the present application, and therefore, the present application is not limited by the following specific embodiments disclosed as below.

Next, “an embodiment” or “embodiments” mentioned herein refers to specific features, structures or characteristics included in at least one implementation of the present application. Therefore, the phrase “in an embodiment” appearing in different places throughout the description does not always refer to the same embodiment or an embodiment separately or selectively exclusive with other embodiments.

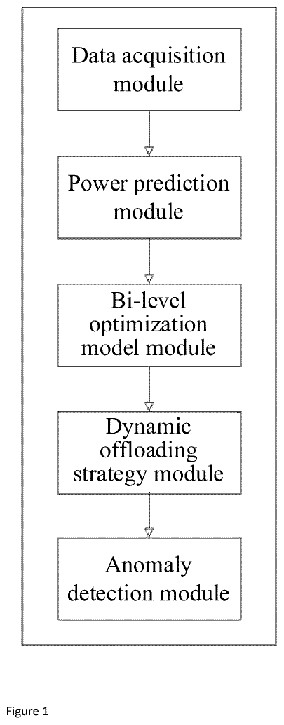

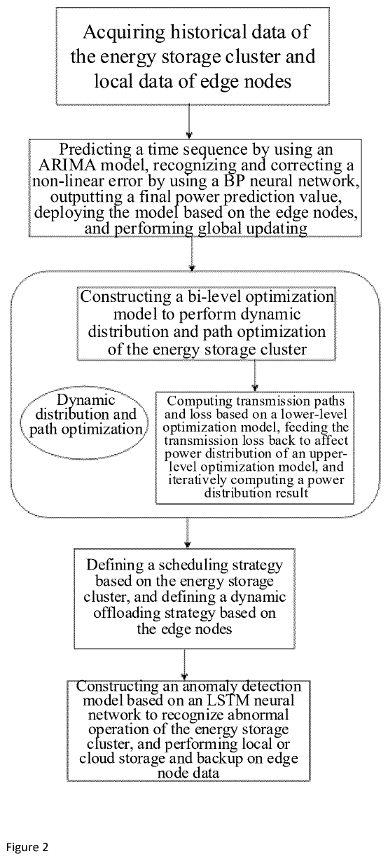

Embodiment 1, referring to FIG. 1 and FIG. 2, shown is a first embodiment of the present application. The embodiment provides an edge-computation-based dynamic optimization control system for an energy storage cluster. The edge-computation-based dynamic optimization control system for an energy storage cluster includes:

S1, historical data of the energy storage cluster and local data of edge nodes are acquired;
preferably, the step that historical data of the energy storage cluster and local data of edge nodes are acquired includes:
data acquisition and normalization are performed based on the historical data, including real-time operation state data of a power output, a load, a voltage and a current of each node and further including environmental variable data of a temperature and a humidity, of the energy storage cluster; and
acquisition and storage are performed according to the local data corresponding to the edge nodes of the energy storage cluster.

By means of the acquisition of the historical data (such as a power output and a load) of the energy storage cluster in conjunction with the normalization for a real-time operation state (such as the voltage and the current) and environmental variables (such as the temperature and the humidity), data support is provided for predicting an energy storage demand and a load, and data normalization can ensure that data with different units, ranges and magnitudes can be uniformly processed, so that influences of noise and abnormal values on system decisions are reduced.

S2, a time sequence is predicted by using an ARIMA model, a non-linear error is recognized and corrected by using a BP neural network, a final power prediction value is outputted, the model is deployed based on the edge nodes, and global updating is performed;
preferably, the step that a time sequence is predicted by using an ARIMA model, a non-linear error is recognized and corrected by using a BP neural network, and a final power prediction value is outputted includes:
a prediction operation of the time sequence is performed based on normalized historical power data of the energy storage cluster by using the ARIMA model, which is formulated as:

$${P}_{t} = {\sum }_{i = 1}^{p} {α}_{i} {P}_{t - i} + {\sum }_{j = 1}^{q} {β}_{i} {∈}_{t - j} ;$$

wherein Pₜ represents a power prediction value at a time point t, Pₜ₋ᵢ represents historical power data of time t-i, Σₜ₋ⱼ represents an error at a time point t-j, αᵢ represents an autoregressive term coefficient, βᵢ represents a moving average term coefficient, p and q respectively represent an autoregressive order and a moving average order, determining an autoregressive term order p and a moving average term order q of the ARIMA model based on an autocorrelation function (ACF) and a partial autocorrelation function (PACF) by using ACF and PACF plots, in the ACF plot, the significant attenuation of a lag value can help to determine an appropriate q value, and in the PACF plot, the truncation of the lag value can be used for determining p;
parameter estimation is performed on the ARIMA model by maximum likelihood estimation (MLE), and αᵢ and βᵢ are optimized and determined by the MLE by means of a historical data training model;
a BP neural network model including an input layer, a hidden layer and an output layer is constructed, wherein the input layer inputs an output of the ARIMA model, the hidden layer recognizes and corrects the non-linear error outputted by the ARIMA model, and the output layer outputs the final power prediction value, which is formulated as:

$$E = \frac{1}{2} {\sum }_{t = 1}^{N} {( {P}_{t , act} - {P}_{t , pre} )}^{2} ;$$

wherein P_{t,act} represents a real power value, P_{t,pre} represents a predicted power value, N represents the total number of real data, and E represents an error term;
the model is trained by using a training set, a cross entropy loss function is selected to compute a difference of predicted and actual labels of the BP neural network model, gradient descent optimization is performed by using an Adam optimizer, a weight of the BP neural network model is updated, and iteratively outputting model parameters for updating the model is stopped when the loss of the model is no longer reduced significantly in a process of continuous iteration; and
after power prediction is completed, the sum of linear prediction of the ARIMA model and non-linear error correction of the BP neural network is used as the final power prediction value and a basis for next optimal scheduling.

By means of the ARIMA model, seasonal fluctuations and periodic changes in a power output can be captured, so that an energy storage system can more accurately predict a further power demand and load fluctuation; by means of the BP neural network, a non-linear trend that cannot be recognized by the ARIMA model can be captured in a training process, and the non-linear error during prediction can be recognized and corrected; by means of combination between an ARIMA and BP neural network, the system can accurately predict the future power demand and provide a reliable basis for the optimal scheduling; by means of short-term trend prediction of ARIMA and error correction of the BP neural network, the system can more rapidly make a response to power fluctuation and optimize power distribution, so that the stable operation of the energy storage system in a grid can be guaranteed; by analyzing the ACF and PACF plots, the autoregressive (AR) order and the moving average order in the ARIMA model can be determined, and thus, an appropriate model is established, wherein trial and error processes are reduced by analyzing the ACF and PACF plots, so that the model structure is more reasonable; by maximizing a probability that observation data appears under a given model, optimal parameters are estimated; and by means of short-term trend prediction of ARIMA and error correction of the BP neural network, the system can more rapidly make a response to power fluctuation and optimize power distribution, so that the stable operation of the energy storage system in a grid can be guaranteed.

Further, the step that the model is deployed based on the edge nodes, and global updating is performed includes:
a local BP neural network model is respectively trained for each edge node, wherein used training data is local historical power data;
after local training is completed, updated model parameters (such as a weight and a bias) are sent to a central server;
the central server performs weighted average on model parameters of all the nodes to update a global model; and
the updated global model is sent back to each edge node for next round of training.

By training the local BP neural network model on each edge node, the system can make full use of distributed computing resources, thereby avoiding the overhead for transmitting all the data to the central server; by only transmitting parameters (such as the weight and the bias) of the model other than an entire data set, the system can greatly reduce demands on the network bandwidth; after the central server performs the weighted average on the model parameters of each edge node, the updated global model has broader representation and can be combined with local information of each edge node, thereby increasing the convergence speed of the global model; and by aggregating the model parameters of the different nodes, the system can acquire data training results from all different environments, load situations and power features, thereby improving the generalization ability of the global model.

S3, a bi-level optimization model is constructed to perform dynamic distribution and path optimization of the energy storage cluster, transmission paths and loss are computed based on a lower-level optimization model, the transmission loss is fed back to affect power distribution of an upper-level optimization model, and a power distribution result is iteratively computed;
preferably, the step that a bi-level optimization model is constructed to perform dynamic distribution and path optimization of the energy storage cluster includes:
based on computation for the final power prediction value, the bi-level optimization model including the upper-level optimization model and the lower-level optimization model is constructed to perform dynamic distribution and path optimization of the energy storage cluster;
modules or devices receiving and consuming electric energy released by energy storage units are defined as load nodes;
an objective of the upper-level optimization model is defined as minimizing total energy consumption and operation costs, wherein an objective function is formulated as:

$$min {F}_{e n} = {\sum }_{i = 1}^{M} ( {C}_{s t , i} + {C}_{lo , i} ) ;$$

wherein Fₑₙ represents the total power consumption, M represents the total number of energy storage nodes, C_{st,i} represents a power consumption cost of an i^{th} energy storage node, and C_{lo,i} represents a power consumption cost of an i^{th} load node;
based on battery power limitation of the energy storage nodes, ability states of the energy storage nodes are defined to be located within the maximum and minimum energy storage capacity ranges of a battery, and meanwhile, power constraint conditions are defined, which is formulated as:

$${P}_{lo} ( t ) = {P}_{re} ( t ) + {P}_{b a} ( t ) + {P}_{g r} ( t ) ;$$

wherein Pₗₒ(t) represents load demand power at time t, Pᵣₑ(t) represents power generated by renewable energy at the time t, P_{ba}(t) represents discharging power of the energy storage nodes at the time t, and P_{gr}(t) represents power of the grid at the time t;
an objective of the lower-level optimization model is defined as finding a transmission path with the minimum loss between the energy storage units and the load nodes by using a shortest path algorithm, wherein an objective function is formulated as:

$$min s = {\sum }_{i = 1}^{M} {\sum }_{j = 1}^{B} {l}_{i , j} ;$$

$${l}_{i , j} = {R}_{i , j} \cdot {I}_{i , j}^{2} ;$$

wherein M and B respectively represent the number of the energy storage nodes and the number of the load nodes, l_{i,j} represents power transmission loss between an energy storage node i and a load node j, s represents total transmission loss, R_{i,j} represents line resistance between the nodes i and j, and I_{i,j} represents a current between the nodes i and j; and
the shortest path from the energy storage nodes to the load nodes is computed by adopting a Dijkstra algorithm, transmission power loss including the energy storage nodes and the load nodes and used for assignment computation for each edge is set, with the energy storage nodes as original points, all nodes j adjacently connected with the energy storage node i are traversed, and the shortest path from the energy storage nodes to the load nodes is updated; and when access to all the load nodes is completed, the algorithm is stopped, the shortest path from the energy storage units to the load nodes and a corresponding loss value are outputted.

Under a synergistic effect of the bi-level optimization model, the system will output a final power distribution solution and a transmission path optimization result to ensure, under the fluctuation of a load demand and power supply, that the system can efficiently operate, reduce energy consumption, and maximize the utilization of renewable energy; the dynamic power distribution of the energy storage system is combined with power transmission path optimization; by means of the bi-level optimization model, global optimal power management is implemented, and not only is the energy efficiency of the system increased, but also loss in power transmission is reduced; by dynamically adjusting a power distribution strategy of the energy storage system in conjunction with real-time path optimization, the system can efficiently operate under different load conditions and maximize the utilization of renewable energy; wherein upper-level optimization: the power distribution strategy of each energy storage unit is optimized based on a predicted power demand and battery state so that the renewable energy is utilized as much as possible; and lower-level optimization: the shortest path between the energy storage units and the load nodes is computed by using an upper-level power distribution result to ensure that the loss of energy transmission is minimum; and by means of the Dijkstra algorithm, the shortest path from a starting point to an objective node can be found in weighted plots;
the power consumption costs of the energy storage nodes and the load nodes are considered in the objective function of the upper-level optimization model. By optimizing the power consumption of the energy storage nodes, the system can reduce the entire operation cost; due to power restrictions of the energy storage nodes, unnecessary power loss can be avoided when the system uses electric energy, and thus, operation costs of the energy storage units and power costs of the load nodes are reduced;
based on the maximum and minimum energy storage capacity restrictions of an energy storage node battery, the system can ensure the flexibility and accuracy of power scheduling under the conditions of dynamic power demands and renewable energy fluctuation; due to the dynamic scheduling of the energy storage units, the system can flexibly adjust the charging and discharging behaviors of the energy storage units according to the load demand, the power output of the renewable energy and power of the grid, thereby better coping with the change of a real-time power demand; and
the lower-level optimization model computes the shortest path from the energy storage nodes to the load nodes by adopting the Dijkstra algorithm and selects the power transmission path with the minimum loss based on the objective function of power transmission loss; by optimizing the power transmission path, the energy storage system can rapidly make a response and select the optimal path for power transmission when demands of the load nodes are changed; and by reasonably distributing the power output of the energy storage units and avoiding excessive discharging or charging, use modes of the energy storage units can be optimized, and the service life of an energy storage device can be prolonged.

Further, the step that transmission paths and loss are computed based on a lower-level optimization model, the transmission loss is fed back to affect power distribution of an upper-level optimization model, and a power distribution result is iteratively computed includes:
the power distribution is initialized, and each energy storage node performs distribution according to remaining power thereof and demands of the load nodes, which is formulated as:

$${P}_{i , j}^{i n} = \frac{{E}_{i} ( t )}{{\sum }_{k = 1}^{B} {D}_{k} ( t )} \cdot {D}_{j} ( t ) ;$$

wherein

$${P}_{i , j}^{i n}$$

represents power distributed to the load node j by an energy storage node, Eᵢ(t) represents total available energy of the energy storage units at time t, Dₖ(t) and Dⱼ(t) respectively represent energy demands of load nodes j and k at the time t, and B represents the number of the load nodes;
initially distributed power of each energy storage unit is computed and is substituted into the objective function of the upper-level optimization model, and total consumption of initial power distribution is computed, which is formulated as:

$${F}_{i n} = {\sum }_{i = 1}^{M} {\sum }_{j = 1}^{B} ( {C}_{st , i} \cdot {P}_{i , j}^{i n} + {C}_{lo , j} \cdot {P}_{i , j}^{i n} ) ;$$

wherein Fᵢₙ represents a total cost of power distribution, and C_{st,i} and C_{lo,j} respectively represent a power consumption cost of the energy storage node i and a power demand cost of the load node j;
the transmission paths and loss between the energy storage nodes and the load nodes are computed based on the lower-level optimization model by adopting the Dijkstra algorithm, and the transmission loss is fed back to affect the power distribution of the upper-level optimization model, which is formulated as:

$${F}_{t o t} = {\sum }_{i = 1}^{M} {\sum }_{j = 1}^{B} ( {C}_{st , i} \cdot {P}_{i , j}^{i n} + {C}_{lo , j} \cdot {P}_{i , j}^{i n} + {l}_{i , j} ) ;$$

wherein Fₜₒₜ represents a total power cost including a power distribution cost and a transmission cost;
a power distribution strategy is adjusted by using a gradient descent method according to the feedback transmission loss, and the objective function Fₜₒₜ is minimized to compute a new power distribution solution, which is formulated as:

$$∇ {P}_{i , j} = \frac{\partial {F}_{t o t}}{\partial {P}_{i , j}} = {C}_{s t , i} + {C}_{lo , j} + \frac{\partial {l}_{i , j}}{\partial {P}_{i , j}} ;$$

$${P}_{i , j}^{n} = {P}_{i , j}^{o} - η \cdot ∇ {P}_{i , j} ;$$

wherein ∇P_{i,j} represents a gradient of power distribution P_{i,j} to a total cost, ∇P_{i,j} represents an influence of the change of power distribution on the total cost,

$$\frac{\partial {F}_{tot}}{\partial {P}_{i , j}}$$

represents a partial derivative of the objective function Fₜₒₜ to the power distribution P_{i,j},

$$\frac{\partial {l}_{i , j}}{\partial {P}_{i , j}}$$

represents a partial derivative of the power transmission loss l_{i,j} to the power distribution

$${P}_{i , j} , {P}_{i , j}^{n} and {P}_{i , j}^{o}$$

respectively represent updated and un-updated power distribution, and n represents a learning rate;
a convergence threshold (the convergence threshold is a minimal value) is defined based on the historical data, and when a variable of the objective function is lower than a preset convergence threshold in a plurality of iterations of power distribution, iteration is stopped to obtain a final power distribution result.

By computing the shortest path and the transmission loss between the energy storage nodes and the load nodes and feeding the same back to the upper-level optimization model by the lower-level optimization model, the system can more precisely adjust the power distribution; by means of a feedback mechanism, it can be ensured that the power distribution solution not only considers a distributed power demand, but also considers energy loss in the transmission path, thereby improving the accuracy of power distribution and increasing the entire operation efficiency of the system; and an objective of the upper-level optimization model is to minimize the total energy consumption and the operation cost. By means of the feedback of the initial power distribution and the transmission loss, the system can optimize the power distribution; the lower-level optimization model quantizes the transmission loss by computing a resistance and a current in the transmission path, and feeds the transmission loss back to the upper-level optimization model for adjustment, so that the system can select a more efficient power transmission path to further reduce the entire energy consumption and operation cost; the gradient descent method is used for iteratively adjusting the power distribution strategy over and over again, so that the system can perform adaptive adjustment under a real-time condition; with the feedback of the transmission loss and the power consumption, the system can automatically optimize the power distribution solution to ensure that each energy storage node dynamically adjusts the output power thereof according to the load demand and transmission conditions, so that an adaptive power distribution mechanism can better cope with fluctuation and emergency situations in the energy storage system; by means of iterative optimization for the power distribution and the transmission path, the system can flexibly cope with different load demands and the change of power situations of the energy storage nodes; and in each iteration, the power distribution solution is adjusted to adapt to the change of actual power transmission conditions and load demands, thereby improving the robustness of the system.

S4, a scheduling strategy is defined based on the energy storage cluster, and a dynamic offloading strategy is defined based on the edge nodes;
preferably, the step that a scheduling strategy is defined based on the energy storage cluster includes:
a load demand, renewable energy power generation, energy storage system discharge and grid power supply are balanced, and it is clarified that the sum of renewable energy power, grid power and discharging power of the energy storage units is equal to the sum of a total load demand and charging power of an energy storage system; and
the scheduling strategy is defined, a power output of renewable energy is checked, if the output of the renewable energy exceeds the load demand, the energy storage units are charged, if the output of the renewable energy is not enough to meet the load demand, insufficient power is complemented by the energy storage units, and if the energy storage units are not enough to meet the load demand either, complementation is performed by means of a grid.

By giving priority to the use of renewable energy generation and performing energy storage for charging the waste of energy is effectively avoided; by complementing a load by using the energy storage system when the renewable energy is insufficient, dependency on the grid is lowered again, so that demands on fossil energy power generation are reduced, and the total energy efficiency of the system is increased; and by means of the strategy, the system can perform flexible adjustment according to the change of power generation capacity of the renewable energy, the remaining energy of the energy storage system, and the load demand, thereby ensuring that the load demand can be met all the time.

Further, the step that a dynamic offloading strategy is defined based on the edge nodes includes:
the dynamic offloading strategy is defined based on the edge nodes completing training, operation data of each edge node is monitored in real time, a load rate is computed, and meanwhile, a network bandwidth is monitored;
an offloading feasibility index is computed for an edge node task, which is formulated as:

$${I}_{k} = \frac{{T}_{lo , k} - {T}_{ed , k}}{{T}_{lo , k}} \cdot \frac{{R}_{av}}{{R}_{k}} \cdot \frac{{U}_{n} ( t )}{{C}_{n}} ;$$

wherein Iₖ represents an offloading feasibility index of a k^{th} task, T_{lo,k} represents delay time of local processing of the task k, T_{ed,k} represents delay time of processing from the task k to an edge cloud, Rₐᵥ represents the current available network bandwidth, Rₖ represents a bandwidth required for offloading the task k, Cₙ represents the maximum computing power of an edge node n, and Uₙ(t) represents the current performance utilization rate of the node n;
a feasibility index of an offloadable task is computed based on the historical data, and the sum of an average value and a standard deviation is used as a feasibility threshold, and if Iₖ is greater than or equal to the feasibility threshold, it is indicated that the task k is offloadable;
an offloading decision variable xx is determined based on a judgment whether the task k is offloaded or not, if the task k is offloaded to the edge cloud, 1 is indicated, or otherwise, 0 is indicated;
an execution condition is defined, if T_{lo,k} is greater than T_{ed,k}, it is indicated that the task is offloadable, if a total bandwidth demand of an offloaded task is less than Rₐᵥ, it is indicated that the task is offloadable, and if the load rate of the edge nodes exceeds the maximum load rate, it is indicated that the task is offloadable;
a dynamic decision is defined based on a minimized total energy consumption and delay, which is formulated as:

$$min G = {\sum }_{k = 1}^{K} ( {x}_{k} \cdot ( {T}_{e d , k} + {E}_{e d , k} ) + ( 1 + {x}_{k} ) \cdot ( {T}_{lo , k} + {E}_{lo , k} ) ) ;$$

wherein minG represents a minimized optimization objective, K represents the total number of tasks, and E_{ed,k} and E_{lo,k} respectively represent energy consumption for offloading the task k to the edge cloud and energy consumption for local processing of the task k;
based on the minimized optimization objective, an offloading task is executed in real time, and network transmission is performed; and the task is assigned to a cloud node for processing; and
the offloaded task is continuously monitored to ensure that the offloading task is completed within a preset time, and if network congestion or excessive delay occurs in an offloading process, the system tries to reassign the task to be executed locally.

By monitoring the operation data of the edge nodes in real time and computing the load rate, the dynamic offloading strategy can intelligently offload the task to the edge cloud; the dynamic offloading strategy minimizes the total energy consumption to optimize the task assignment, thereby ensuring that the optimal balance point is found between local processing and edge cloud offloading; by offloading a task with a high computing demand to the edge cloud, the system can reduce the energy consumption of local nodes while avoiding excessive transmission power consumption; by optimizing the energy consumption, the used energy is significantly reduced during long-term operation of the system; by monitoring the network bandwidth and bringing the network bandwidth into the offloading decision, the system can ensure that the task is offloaded only under allowable network conditions; by reassigning the task to be processed locally according to network congestion or task delay in a task offloading process, it is ensured that the system can still maintain the normal operation of the task even if there is a problem in cloud processing, so that the robustness of the system is enhanced; and by means of the dynamic offloading strategy for each edge node, the solution can adapt to a large-scale distributed computing scenario, thereby guaranteeing the efficient utilization of computing resources and the on-time completion of the task.

S5, an anomaly detection model is constructed based on an LSTM neural network to recognize abnormal operation of the energy storage cluster, and local or cloud storage and backup are performed on edge node data;
preferably, the step that an anomaly detection model is constructed based on an LSTM neural network to recognize abnormal operation of the energy storage cluster includes:
the anomaly detection model including an input layer, an LSTM layer and an output layer is constructed based on the LSTM neural network, wherein the input layer inputs historical operation data of the energy storage cluster, the LSTM layer is used for capturing dynamic changes in the time sequence, and the output layer outputs an operation state of an energy storage cluster of the next time step;
a difference of a predicted result and an actual label of the anomaly detection model is computed by using a training set and selecting a cross entropy loss function, gradient descent optimization is performed by using an Adam optimizer, parameters of the anomaly detection model are updated, and iteratively outputting model parameters is stopped when the loss of the model is no longer reduced significantly in a process of continuous iteration; and
the sum of an average value and a double standard deviation based on the historical data is used as an anomaly threshold, and if a predicted output of the anomaly detection model is greater than the anomaly threshold, it is regarded that the operation of the energy storage units is abnormal, and dynamic load balancing scheduling is performed based on the number of other unfailed energy storage units, which is formulated as:

$${P}_{i , n} = {P}_{i , o} + \frac{{P}_{fa}}{Z - 1} ;$$

wherein P_{i,n} represents a new power distribution value after the load is balanced, P_{i,o} represents a power before the load is balanced; P_{fa} represents a power of a failed energy storage unit, and Z represents the total number of the energy storage units.

By means of the neural network good at processing time sequence data, the dynamic change of the historical data in the energy storage cluster can be captured, a potential abnormal mode in the energy storage system can be recognized, and possible failure can be predicted in advance, so that the prediction precision for the state of the energy storage system is improved, and sudden failure generated in the operation of the system is reduced; by means of the anomaly detection based on the LSTM model, the operation state of the energy storage cluster can be captured in real time, particularly, the system can rapidly make a response when abnormal fluctuation of data such as a power output, a load, a voltage and a current occurs; by comparing the predicted output with the anomaly threshold, the system can recognize the abnormal operation of the energy storage system in time, thereby improving the reliability and security of the system; and by dynamically adjusting the power distribution of the energy storage units, the unfailed energy storage units can effectively bear a load of a failed unit, so that the waste of power resources is avoided, the energy utilization rate of the system can be increased, and the efficient management and use of the power resources are guaranteed.

Further, the step that local or cloud storage and backup are performed on edge node data includes:
an anomaly alarm is given to maintenance personnel by means of an alarm based on a judgment whether the operation of the energy storage units is abnormal;
data encryption is performed on recorded alarm time and the data by adopting RSA, and the data is transmitted to a cloud database by adopting a TLS protocol; and
local backup and cloud storage are synchronously performed on the data of the edge nodes and the central server.

By encrypting the alarm time and the data by adopting the RSA encryption technology, the system can ensure that sensitive information cannot be stolen or tampered in a process of data transmission; by using TLS (Transport Layer Security), it is ensured that the data will not be subject to man-in-the-middle attack or network eavesdropping in a transmission process; by means of an anomaly alarm mechanism, it is beneficial for maintenance personnel to take an action in time to avoid failure expansion or system interruption, thereby improving the entire operation stability and failure handling efficiency of the system; and by means of a double data storage way of local backup and cloud storage, the system ensures that all abnormal data and alarm information are saved safely.

### Embodiment 2

When the function is implemented in a form of a software function unit and sold or used as an independent product, the function may be stored in a computer-readable storage medium. Based on such understanding, the essences of the technical solutions of the present application or parts thereof making contributions to the prior art or parts of the technical solutions may be embodied in a form of a software product, and the computer software product is stored in a storage medium and includes a plurality of instructions used to enable a computer device (which may be a personal computer, a server, or a network device, etc.) to perform all or parts of steps of the method in each of the embodiments of the present application. The aforementioned storage medium includes various media capable of storing program codes, such as a U disk, a mobile hard disk, an ROM (Read-Only Memory), an RAM (Random Access Memory), a diskette, and an optical disk.

Logics and/or steps shown in the process diagram or described herein in other ways, such as an ordered list of executable instructions regarded to be used for implementing logic functions, may be specifically implemented in any computer-readable medium so as to be used by instruction execution systems, apparatuses or devices (such as a computer-based system, a system including a processor or other systems capable of acquiring instructions from the instruction execution systems, apparatuses or devices and executing the instructions) or be used in conjunction with the instruction execution systems, apparatuses or devices. For the purpose of the present description, the “computer-readable medium” may be any apparatus capable of including, storing, communicating, propagating or transmitting programs so as to be used by the instruction execution systems, apparatuses or devices or used in conjunction with the instruction execution systems, apparatuses or devices.

More specific examples (non-exhaustive list) of the computer-readable medium are shown as follows: an electric connection part (electronic apparatus) with one or more wirings, a portable computer disk enclosure (magnetic apparatus), a random access memory (RAM), a read-only memory (ROM), an erasable programmable read-only memory (EPROM or flash memory), an optical fiber apparatus, and a portable compact disc read-only memory (CDROM). In addition, the computer-readable medium may be even paper or other appropriate media on which the program can be printed, which is due to a fact, for example, that the program can be acquired in an electronic way by optically scanning the paper or other media, and next processing the same in other appropriate ways during edition, interpretation or requirement, and then, the program is stored in a computer memory.

It should be understood that all parts of the present application may be implemented by means of hardware, software, firmware or their combinations. In the above-mentioned embodiments, the plurality of steps or methods may be implemented by software or firmware stored in a memory and executed by the appropriate instruction execution systems. For example, if they are implemented by means of the hardware, it is the same as that in another embodiment that they may be implemented by any one of the following technologies known in the art or their combinations: a discrete logic circuit with a logic gate circuit for implementing a logic function for a data signal, an application-specific integrated circuit with an appropriate combined logic gate circuit, a programmable gate array (PGA), a field-programmable gate array (FPGA), etc.

It should be noted that above embodiments are only intended to describe the technical solutions of the present application, rather to limit the technical solutions. Although the present application has been described in detail with reference to the preferred embodiments, it should be understood by those of ordinary skill in the art that modifications or equivalent substitutions for the technical solutions of the present application may be made without departing from the spirit and scope of the technical solutions of the present application, and all the modifications or equivalent substitutions shall fall within the scope of the claims of the present application.

1. An edge-computation-based dynamic optimization control system for an energy storage cluster, comprising:
a data acquisition module acquiring historical data of the energy storage cluster and local data of edge nodes;
a power prediction module predicting a time sequence by using an ARIMA (Autoregressive Integrated Moving Average) model, recognizing and correcting a non-linear error by using a BP (Back Propagation) neural network, outputting a final power prediction value, deploying the model based on the edge nodes, and performing global updating;
a bi-level optimization model module constructing a bi-level optimization model to perform dynamic distribution and path optimization of the energy storage cluster, computing transmission paths and loss based on a lower-level optimization model, feeding the transmission loss back to affect power distribution of an upper-level optimization model, and iteratively computing a power distribution result;
a dynamic offloading strategy module defining a scheduling strategy based on the energy storage cluster, and defining a dynamic offloading strategy based on the edge nodes; and
an anomaly detection module constructing an anomaly detection model based on an LSTM (Long Short Term Memory) neural network to recognize abnormal operation of the energy storage cluster, and performing local or cloud storage and backup on edge node data; wherein
the acquiring historical data of the energy storage cluster and local data of edge nodes comprises:
performing data acquisition and normalization based on the historical data, comprising real-time operation state data of a power output, a load, a voltage and a current of each node and further comprising environmental variable data of a temperature and a humidity, of the energy storage cluster; and
performing acquisition and storage according to the local data corresponding to the edge nodes of the energy storage cluster;
the predicting a time sequence by using an ARIMA model, recognizing and correcting a non-linear error by using a BP neural network, and outputting a final power prediction value comprises:
performing a prediction operation of the time sequence based on normalized historical power data of the energy storage cluster by using the ARIMA model, which is formulated as:
$${P}_{t} = {\sum }_{i = 1}^{p} {α}_{i} {P}_{t - i} + {\sum }_{j = 1}^{q} {β}_{i} {∈}_{t - j} ;$$
wherein Pₜ represents a power prediction value at a time point t, Pₜ₋ᵢ represents historical power data of time t-i, ϵₜ₋ⱼ represents an error at a time point t-j, αᵢ represents an autoregressive term coefficient, βᵢ represents a moving average term coefficient, and p and q respectively represent an autoregressive order and a moving average order;
performing parameter estimation on the ARIMA model by maximum likelihood estimation (MLE), and optimizing and determining αᵢ and βᵢ by the MLE by means of a historical data training model;
constructing a BP neural network model comprising an input layer, a hidden layer and an output layer, wherein the input layer inputs an output of the ARIMA model, the hidden layer recognizes and corrects the non-linear error outputted by the ARIMA model, and the output layer outputs the final power prediction value, which is formulated as:
$$E = \frac{1}{2} {\sum }_{t = 1}^{N} {( {P}_{t , act} - {P}_{t , pre} )}^{2} ;$$
wherein P_{t,act} represents a real power value, P_{t,pre} represents a predicted power value, N represents the total number of real data, and E represents an error term;
training the model by using a training set, selecting a cross entropy loss function to compute a difference of predicted and actual labels of the BP neural network model, performing gradient descent optimization by using an Adam optimizer, updating a weight of the BP neural network model, and stopping iteratively outputting model parameters for updating the model when the loss of the model is no longer reduced significantly in a process of continuous iteration; and
after power prediction is completed, using the sum of linear prediction of the ARIMA model and non-linear error correction of the BP neural network as the final power prediction value and a basis for next optimal scheduling;
the deploying the model based on the edge nodes, and performing global updating comprises:
respectively training a local BP neural network model for each edge node, wherein used training data is local historical power data;
after local training is completed, sending updated model parameters to a central server;
performing weighted average on model parameters of all the nodes by the central server to update a global model; and
sending the updated global model back to each edge node for next round of training.

2. The edge-computation-based dynamic optimization control system for an energy storage cluster of claim 1, wherein the constructing a bi-level optimization model to perform dynamic distribution and path optimization of the energy storage cluster comprises:
based on computation for the final power prediction value, constructing the bi-level optimization model comprising the upper-level optimization model and the lower-level optimization model to perform dynamic distribution and path optimization of the energy storage cluster;
defining modules or devices receiving and consuming electric energy released by energy storage units as load nodes;
defining an objective of the upper-level optimization model as minimizing total energy consumption and operation costs, wherein an objective function is formulated as:
$$min {F}_{e n} = {\sum }_{i = 1}^{M} ( {C}_{s t , i} + {C}_{lo , i} ) ;$$
wherein Fₑₙ represents the total power consumption, M represents the total number of energy storage nodes, C_{st,i} represents a power consumption cost of an i^{th} energy storage node, and C_{lo,i} represents a power consumption cost of an i^{th} load node;
defining an objective of the lower-level optimization model as finding a transmission path with the minimum loss between the energy storage units and the load nodes by using a shortest path algorithm, wherein an objective function is formulated as:
$$mins = {\sum }_{i = 1}^{M} {\sum }_{j = 1}^{B} {l}_{i , j} ;$$
$${l}_{i , j} = {R}_{i , j} \cdot {I}_{i , j}^{2} ;$$
wherein M and B respectively represent the number of the energy storage nodes and the number of the load nodes, l_{i,j} represents power transmission loss between an energy storage node i and a load node j, s represents total transmission loss, R_{i,j} represents line resistance between the nodes i and j, and I_{i,j} represents a current between the nodes i and j; and
computing the shortest path from the energy storage nodes to the load nodes by adopting a Dijkstra algorithm.

3. The edge-computation-based dynamic optimization control system for an energy storage cluster of claim 2, wherein the computing transmission paths and loss based on a lower-level optimization model, feeding the transmission loss back to affect power distribution of an upper-level optimization model, and iteratively computing a power distribution result comprises:
initializing the power distribution, and performing distribution by each energy storage node according to remaining power thereof and demands of the load nodes, which is formulated as:
$${P}_{i , j}^{i n} = \frac{{E}_{i} ( t )}{{\sum }_{k = 1}^{B} {D}_{k} ( t )} \cdot {D}_{j} ( t ) ;$$
wherein
$${P}_{i , j}^{i n}$$
represents power distributed to the load node j by an energy storage node, Eᵢ(t) represents total available energy of the energy storage units at time t, Dₖ(t) and Dⱼ(t) respectively represent energy demands of load nodes j and k at the time t, and B represents the number of the load nodes;
computing and substituting initially distributed power of each energy storage unit into the objective function of the upper-level optimization model, and computing total consumption of initial power distribution, which is formulated as:
$${F}_{i n} = {\sum }_{i = 1}^{M} {\sum }_{j = 1}^{B} ( {C}_{st , i} \cdot {P}_{i , j}^{in} + {C}_{lo , j} \cdot {P}_{i , j}^{i n} ) ;$$
wherein Fᵢₙ represents a total cost of power distribution, and C_{st,i} and C_{lo,j} respectively represent a power consumption cost of the energy storage node i and a power demand cost of the load node j;
computing the transmission paths and loss between the energy storage nodes and the load nodes based on the lower-level optimization model by adopting the Dijkstra algorithm, and feeding the transmission loss back to affect the power distribution of the upper-level optimization model, which is formulated as:
$${F}_{t o t} = {\sum }_{i = 1}^{M} {\sum }_{j = 1}^{B} ( {C}_{st , i} \cdot {P}_{i , j}^{in} + {C}_{lo , j} \cdot {P}_{i , j}^{i n} + {l}_{i , j} ) ;$$
wherein Fₜₒₜ represents a total power cost comprising a power distribution cost and a transmission cost;
adjusting a power distribution strategy by using a gradient descent method according to the feedback transmission loss, and minimizing the objective function Fₜₒₜ to compute a new power distribution solution; and
defining a convergence threshold based on the historical data, and when a variable of the objective function is lower than a preset convergence threshold in a plurality of iterations of power distribution, stopping iteration to obtain a final power distribution result.

4. The edge-computation-based dynamic optimization control system for an energy storage cluster of claim 3, wherein the defining a scheduling strategy based on the energy storage cluster comprises:
balancing a load demand, renewable energy power generation, energy storage system discharge and grid power supply, and clarifying that the sum of renewable energy power, grid power and discharging power of the energy storage units is equal to the sum of a total load demand and charging power of an energy storage system; and
defining the scheduling strategy, checking a power output of renewable energy, if the output of the renewable energy exceeds the load demand, charging the energy storage units, if the output of the renewable energy is not enough to meet the load demand, complementing insufficient power by the energy storage units, and if the energy storage units are not enough to meet the load demand either, performing complementation by means of a grid.

5. The edge-computation-based dynamic optimization control system for an energy storage cluster of claim 4, wherein the defining a dynamic offloading strategy based on the edge nodes comprises:
defining the dynamic offloading strategy based on the edge nodes completing training, monitoring operation data of each edge node in real time, computing a load rate, and meanwhile, monitoring a network bandwidth;
computing an offloading feasibility index for an edge node task, which is formulated as:
$${I}_{k} = \frac{{T}_{lo , k} - {T}_{ed , k}}{{T}_{lo , k}} \cdot \frac{{R}_{av}}{{R}_{k}} \cdot \frac{{U}_{n} ( t )}{{C}_{n}} ;$$
wherein Iₖ represents an offloading feasibility index of a k^{th} task, T_{lo,k} represents delay time of local processing of the task k, T_{ed,k} represents delay time of processing from the task k to an edge cloud, Rₐᵥ represents the current available network bandwidth, Rₖ represents a bandwidth required for offloading the task k, Cₙ represents the maximum computing power of an edge node n, and Uₙ(t) represents the current performance utilization rate of the node n;
computing a feasibility index of an offloadable task based on the historical data, and using the sum of an average value and a standard deviation as a feasibility threshold, and if Iₖ is greater than or equal to the feasibility threshold, indicating that the task k is offloadable;
determining an offloading decision variable xx based on a judgment whether the task k is offloaded or not, if the task k is offloaded to the edge cloud, indicating 1, or otherwise, indicating 0;
defining an execution condition, if T_{lo,k} is greater than T_{ed,k}, indicating that the task is offloadable, if a total bandwidth demand of an offloaded task is less than Rₐᵥ, indicating that the task is offloadable, and if the load rate of the edge nodes exceeds the maximum load rate, indicating that the task is offloadable;
defining a dynamic decision based on a minimized total energy consumption and delay, which is formulated as:
$$min G = {\sum }_{k = 1}^{K} ( {x}_{k} \cdot ( {T}_{e d , k} + {E}_{e d , k} ) + ( 1 + {x}_{k} ) \cdot ( {T}_{lo , k} + {E}_{lo , k} ) ) ;$$
wherein minG represents a minimized optimization objective, K represents the total number of tasks, and E_{ed,k} and E_{lo,k} respectively represent energy consumption for offloading the task k to the edge cloud and energy consumption for local processing of the task k;
based on the minimized optimization objective, executing an offloading task in real time, and performing network transmission; and assigning the task to a cloud node for processing; and
continuously monitoring the offloaded task to ensure that the offloading task is completed within a preset time, and if network congestion or excessive delay occurs in an offloading process, trying, by the system, to reassign the task to be executed locally.

6. The edge-computation-based dynamic optimization control system for an energy storage cluster of claim 5, wherein the constructing an anomaly detection model based on an LSTM neural network to recognize abnormal operation of the energy storage cluster comprises:
constructing the anomaly detection model comprising an input layer, an LSTM layer and an output layer based on the LSTM neural network, wherein the input layer inputs historical operation data of the energy storage cluster, the LSTM layer is used for capturing dynamic changes in the time sequence, and the output layer outputs an operation state of an energy storage cluster of the next time step;
computing a difference of a predicted result and an actual label of the anomaly detection model by using a training set and selecting a cross entropy loss function, performing gradient descent optimization by using an Adam optimizer, updating parameters of the anomaly detection model, and stopping iteratively outputting model parameters when the loss of the model is no longer reduced significantly in a process of continuous iteration; and
using the sum of an average value and a double standard deviation based on the historical data as an anomaly threshold, and if a predicted output of the anomaly detection model is greater than the anomaly threshold, regarding that the operation of the energy storage units is abnormal, and performing dynamic load balancing scheduling based on the number of other unfailed energy storage units.

7. The edge-computation-based dynamic optimization control system for an energy storage cluster of claim 6, wherein the performing local or cloud storage and backup on edge node data comprises:
giving an anomaly alarm to maintenance personnel by means of an alarm based on a judgment whether the operation of the energy storage units is abnormal;
performing data encryption on recorded alarm time and the data by adopting RSA (Rivest-Shamir-Adleman), and transmitting the data to a cloud database by adopting a TLS (transport layer security) protocol; and
synchronously performing local backup and cloud storage on the data of the edge nodes and the central server.
